(19) United States
(12) Patent Application Publication
(10) Pub. No.: US 2026/0125081 A1
(43) Pub. Date: May 7, 2026

(54) SYSTEMS AND METHODS FOR IDENTIFYING A GHOST VEHICLE

(71) Applicant: Ford Global Technologies, LLC, Dearborn, MI (US)

(72) Inventors: Stuart C. SALTER, Canton, MI (US); Krishna BANDI, Novi, MI (US); Ryan O'GORMAN, Beverly Hills, MI (US); Brendan DIAMOND, Naples, FL (US); Vyas Darshan SHENOY, Canton, MI (US); Mario Anthony SANTILLO, Canton, MI (US)

(73) Assignee: Ford Global Technologies, LLC, Dearborn, MI (US)

(21) Appl. No.: 18/939,200

(22) Filed: Nov. 6, 2024

(51) Int. Cl. B60W 60/00; G08G 1/00; G08G 1/01

(52) U.S. Cl. CPC B60W 60/00272; G08G 1/0116; G08G 1/0129; G08G 1/0137; G08G 1/22; B60W 2554/4041; B60W 2556/45; B60W 2756/10

(57) ABSTRACT

A method includes the detection of an object in a marshaling environment, a determination of whether one or more conditions is satisfied in response to the detection of the object, a transmission of a request for data originating from one or more sensors of each automated vehicle of one or more automated vehicles, a receipt of the requested data from the one or more automated vehicles, and a performance of one or more corrective actions based on an analysis of the requested data.

### FIELD

The present disclosure relates to identifying a ghost vehicle. More specifically, the present disclosure relates to identifying a ghost vehicle in a marshaling setting.

### BACKGROUND

The statements in this section merely provide background information related to the present disclosure and may not constitute prior art.

Ghost vehicles, or vehicles that do not physically exist, may be detected by infrastructure sensors in marshaling settings. The detection of the ghost vehicles can disrupt marshaling of one or more vehicles as the infrastructure sensors perceive the ghost vehicles as real vehicles, thus attempting to marshal the real vehicles accordingly. The detection of the ghost vehicles thereby results in the marshaling of real vehicles coming to a stop so that the ghost vehicles can be properly identified and the marshaling of the real vehicles may resume without considering the identified ghost vehicles.

The present disclosure address these and other issues related to the identification of a ghost vehicle.

### SUMMARY

This section provides a general summary of the disclosure and is not a comprehensive disclosure of its full scope or all of its features.

The present disclosure provides a method comprising: detecting an object in a marshaling environment; determining whether one or more conditions is satisfied in response to the detection of the object; transmitting, to one or more automated vehicles, a request for data originating from one or more sensors of each automated vehicle of the one or more automated vehicles in response to the one or more conditions being satisfied; receiving, from the one or more automated vehicles, the requested data; and performing one or more corrective actions based on an analysis of the requested data; wherein the one or more conditions includes one or more of: an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles; wherein the analysis of the requested data comprises: determining whether a sensor output associated with one or more sensors of an infrastructure system matches the requested data; wherein the performance of the one or more corrective actions is further based on a determination that the sensor output does not match the requested data; wherein the performance of the one or more corrective actions includes one of: initiating one or more reset routines; switching from a first set of one or more sensors of an infrastructure system to a second set of one or more sensors of the infrastructure system; and causing each automated vehicle of the one or more automated vehicles to follow one or more movements of a preceding automated vehicle of the one or more automated vehicles and for a lead automated vehicle of the one or more automated vehicles to follow a historical pathway; and wherein the performance of the one or more corrective actions includes: collecting metadata associated with the object; determining one or more object-prone areas within the marshaling environment; and generating a recommendation to replace one or more sensors of an infrastructure system or to install a second set of one or more sensors based on the determination of the one or more object-prone areas.

The present disclosure provides another method comprising: detecting an object in a marshaling environment; determining whether one or more conditions is satisfied in response to the detection of the object; transmitting, to one or more automated vehicles, one or more instructions for analyzing data originating from one or more sensors of each automated vehicle of the one or more automated vehicles in response to the one or more conditions being satisfied; receiving, from the one or more automated vehicles, one or more results associated with an analysis of the data performed by the one or more automated vehicles; and performing one or more corrective actions based on the one or more results associated with the analysis of the data; wherein the one or more conditions includes one or more of: an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles; wherein the analysis of the data by the one or more automated vehicles further comprises: analyzing one or more video recordings of the marshaling environment from each automated vehicle of the one or more automated vehicles; and verifying a location of the object based on the analysis of the one or more video recordings; wherein the performance of the one or more corrective actions includes one of: initiating one or more reset routines; switching from a first set of one or more sensors of an infrastructure system to a second set of one or more sensors of the infrastructure system; and causing each automated vehicle of the one or more automated vehicles to follow one or more movements of a preceding automated vehicle of the one or more automated vehicles and for a lead automated vehicle of the one or more automated vehicles to follow a historical pathway; and wherein the performance of the one or more corrective actions include: collecting metadata associated with the object; determining one or more object-prone areas within a marshaling environment; and generating a recommendation to replace one or more sensors of an infrastructure system or to install a second set of one or more sensors based on the determination of the one or more object-prone areas.

The present disclosure provides a system comprising: an infrastructure system configured to: detect an object in a marshaling environment, determine whether one or more conditions is satisfied in response to the detection of the object, transmit a request for data originating from one or more sensors of each automated vehicle of one or more automated vehicles in response to the one or more conditions being satisfied, receive the requested data, and perform one or more corrective actions based on an analysis of the requested data; and one or more automated vehicles configured to: receive the request for the data originating from the one or more sensors of each automated vehicle of the one or more automated vehicles, and transmit the requested data; wherein the one or more automated vehicles is further configured to: receive one or more instructions for analyzing the data originating from the one or more sensors of each automated vehicle of the one or more automated vehicles in response to the one or more conditions being satisfied; and transmit one or more results associated with the analysis of the data performed by the one or more automated vehicles; wherein the infrastructure system is further configured to: transmit the one or more instructions for analyzing the data originating from the one or more sensors of each automated vehicle of the one or more automated vehicles; and receive the one or more results; wherein performing the analysis of the data by the one or more automated vehicles comprises: analyzing one or more video recordings of the marshaling environment from each automated vehicle of the one or more automated vehicles; and verifying a location of the object based on the analysis of the one or more video recordings; wherein the one or more conditions includes one or more of: an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles; wherein analyzing the requested data by the infrastructure system comprises: determining whether a sensor output associated with one or more sensors of the infrastructure system matches the requested data; wherein the performance of the one or more corrective actions is further based on a determination that the sensor output does not match the requested data; wherein performing the one or more corrective actions by the infrastructure system comprises one of: initiating one or more reset routines; switching from a first set of one or more sensors of the infrastructure system to a second set of one or more sensors of the infrastructure system; and causing each automated vehicle of the one or more automated vehicles to follow one or more movements of a preceding automated vehicle of the one or more automated vehicles and for a lead automated vehicle of the one or more automated vehicles to follow a historical pathway; and wherein performing the one or more corrective actions by the infrastructure system comprises: collecting metadata associated with the object; determining one or more object-prone areas within the marshaling environment; and generating a recommendation to replace one or more sensors of the infrastructure system or to install a second set of one or more sensors based on the determination of the one or more object-prone areas.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 is a process flow diagram illustrating an example method for identifying a ghost vehicle in accordance with one or more embodiments of the present disclosure;

FIG. 4 is a flowchart illustrating another example method for identifying a ghost vehicle in accordance with one or more embodiments of the present disclosure;

FIG. 5 is a process flow diagram illustrating another example method for identifying a ghost vehicle in accordance with one or more embodiments of the present disclosure;

FIG. 6 is a flowchart is a flowchart illustrating another example method for identifying a ghost vehicle in accordance with one or more embodiments of the present disclosure; and

FIG. 7 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provides a means for identifying a ghost vehicle within a marshaling setting. In one or more embodiments, a means for validating a ghost vehicle is provided through a self-diagnostic software process. In one or more embodiments, a method utilizes one or more discrete systems that are independent of one another and that serve different use cases. This method, coupled with a self-diagnostic software process configured to analyze a marshaling performance, allows for a software-based evaluation that is both independently redundant in the analysis performed and the data collected. This method is able to identify the output of unique results associated with an infrastructure system relative to other inputs and/or a software routine. In one or more embodiments, a system is provided that relies on independent confirmation of data that looks for differences in one or more evaluations performed by unique and independent systems that can include one or more systems that are being observed and/or evaluated themselves. Thus, an enhanced identification of which data sets are real and not real is provided by the comparison of an operational system, an independent system, and/or a device associated with one or more other systems with an independent analysis performed by a software routine.

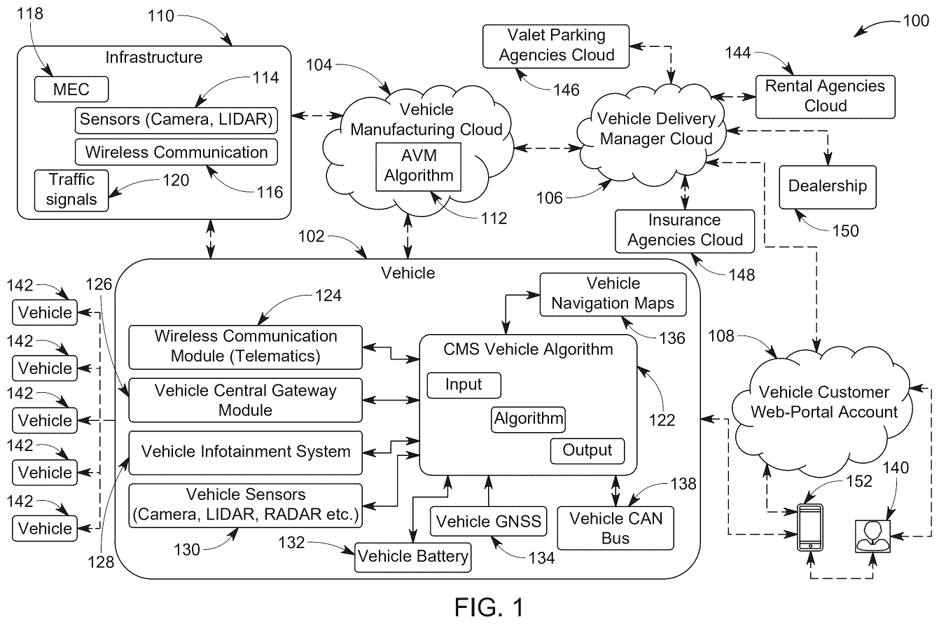

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a vehicle manufacturing cloud system 104, a vehicle delivery manager cloud system 106, a vehicle customer web-portal account cloud system 108, and an infrastructure system 110. The vehicle manufacturing cloud system 104 operates as the central cloud system that manages and/or facilitates any manufacturing process associated with the vehicle 102. The vehicle manufacturing cloud system 104 is configured to wirelessly communicate with the vehicle delivery manager cloud system 106 and/or the infrastructure system 110. The vehicle manufacturing cloud system 104 is also configured to wirelessly communicate with the vehicle 102.

The vehicle manufacturing cloud system 104 can include an infrastructure-side AVM algorithm 112. The infrastructure-side AVM algorithm 112 processes status information associated with at least the vehicle 102 of the one or more vehicles. It is understood that the infrastructure-side AVM algorithm 112 processes status information associated with each vehicle of the one or more vehicles (e.g., the vehicle 102), in one or more embodiments. The vehicle manufacturing cloud system 104 is configured to cause the infrastructure system 110 to monitor the progression of the one or more vehicles (e.g., the vehicle 102) as the vehicle(s) progress through a marshaling environment. For example, the marshaling environment can represent a plant marshaling setting, an automated charging setting, a depot marshaling setting, or an underground parking setting. As an example, the plant marshaling setting can include an instance wherein just-built vehicles are moved through end-of-line testing at a vehicle assembly plant via overhead vision sensing (e.g., one or more sensors 114). As another example, the automated charging setting can include an instance wherein vehicles are correctly allocated to automated charging modalities located outdoor or indoor. As a further example, the depot marshaling setting can include an instance wherein a commercial fleet of vehicles are moved through warehouses and depots to load and/or process items automatically. As an additional example, the underground parking setting can include an instance wherein vehicles are moved through underground or covered parking environments with a potentially inconsistent communication network such as a global navigation satellite system.

The vehicle manufacturing cloud system 104 is also configured to cause the infrastructure system 110 to communicate with the one or more vehicles. For example, the vehicle manufacturing cloud system 104 utilizes the infrastructure-side AVM algorithm 112 to send instructions to the infrastructure system 110 and/or to process information received from the infrastructure system 110. The vehicle manufacturing cloud system 104 is also configured to cause the vehicle delivery manager cloud system 106 to facilitate a delivery of the one or more vehicles (e.g., the vehicle 102) to various locations. For example, the vehicle manufacturing cloud system 104 utilizes the infrastructure-side AVM algorithm 112 to send instructions to the vehicle delivery manager cloud system 106 and/or to process information received from the vehicle delivery manager cloud system 106.

The vehicle manufacturing cloud system 104 is further configured to communicate directly with the one or more vehicles to cause the one or more vehicles to start, stop, or pause progression through the marshaling environment. The vehicle manufacturing cloud system 104 is further configured to control a marshaling speed of the one or more vehicles as the one or more vehicles travel through (e.g., traverse) the marshaling environment. For example, the vehicle manufacturing cloud system 104 utilizes the infrastructure-side AVM algorithm 112 to send instructions to the vehicle 102 and/or to process information received from the vehicle 102.

The infrastructure system 110 includes the one or more sensors 114, a wireless communication component 116, a multi-access edge computing (MEC) system 118, and one or more traffic signals 120. It is understood that the MEC system 118 is configured to support communication between the wireless communication component 116 and the vehicle 102. It is further understood, however, that the MEC system 118 is also configured to support communication between the wireless communication component 116 and any of the vehicle manufacturing cloud system 104, the vehicle delivery manager cloud system 106, and/or the vehicle customer web-portal account cloud system 108. For example, the wireless communication component 116 may utilize GPS, Wi-Fi, satellite, 3G/4G/5G, and/or Bluetooth® to communicate with the one or more vehicles.

The wireless communication component 116 also communicates with the one or more sensors 114 that is configured to manage and/or include, for example, one or more of cameras, lidar, radar, and/or ultrasonic devices. The one or more sensors 114 monitors the movement of the one or more vehicles as the vehicle(s) are marshaled through the marshaling environment. Additionally, the wireless communication component 116 is also in communication with the traffic signals 120. For example, the wireless communication component 116 may cause the traffic signals 120 to direct traffic of the one or more vehicles as the one or more vehicles are marshaled through the marshaling environment. It is understood that the infrastructure system 110 can forward instructions received from the vehicle manufacturing cloud system 104 to the vehicle 102. However, it is also understood that the infrastructure system 110 can send instructions to the vehicle 102 directly through the utilization of the MEC system 118, for example.

The vehicle 102 includes a vehicle-side AVM algorithm 122, a wireless transmission module 124, a vehicle central gateway module 126, a vehicle infotainment system 128, one or more vehicle sensors 130, a vehicle battery 132, a vehicle GNSS 134, a vehicle navigation mapping system 136, and a controller area network (CAN) vehicle bus 138. The wireless transmission module 124 may be a transmission control unit (TCU) and/or may be supported by telematically supported subsystems. The wireless transmission module 124 includes one or more sensors that are configured to gather data and send signals to other components of the vehicle 102. The one or more sensors of the wireless transmission module 124 may include a vehicle speed sensor (not shown) configured to determine a current speed of the vehicle 102; a wheel speed sensor (not shown) configured to determine if the vehicle 102 is traveling at an incline or a decline; a throttle position sensor (not shown) configured to determine if a downshift or upshift of one or more gears associated with the vehicle 102 is required in a current status of the vehicle 102; and/or a turbine speed sensor (not shown) configured to send data associated with a rotational speed of a torque converter of the vehicle 102.

The wireless transmission module 124 communicates information, gathered by the one or more sensors, to the vehicle-side AVM algorithm 122. In one embodiment, the vehicle-side AVM algorithm 122 may be disposed as a component within the wireless transmission module 124. For example, the vehicle 102 utilizes the vehicle-side AVM algorithm 122 to process and send information gathered by the one or more sensors to the infrastructure system 110. As another example, the vehicle 102 utilizes the vehicle-side AVM algorithm 122 to process and send information gathered by the one or more sensors to the vehicle manufacturing cloud system 104 directly. The vehicle-side AVM algorithm 122 is configured to communicate information and/or instructions to the wireless transmission module 124 received from the infrastructure system 110 and/or the vehicle manufacturing cloud system 104.

The vehicle central gateway module 126 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 138. The vehicle central gateway module 126 is configured to distribute data communicated to the vehicle central gateway module 126 by each of the various domain bus systems to other components of the vehicle 102. The vehicle central gateway module 126 is also configured to distribute information received from the vehicle-side AVM algorithm 122 to the various domain bus systems. The vehicle central gateway module 126 is further configured to send information to the vehicle-side AVM algorithm 122 received from the various domain bus systems. For example, the vehicle 102 utilizes the vehicle-side AVM algorithm 122 to process and send information received from the vehicle central gateway module 126 to the infrastructure system 110. As another example, the vehicle 102 utilizes the vehicle-side AVM algorithm 122 to process and send information received from the vehicle central gateway module 126 to the vehicle manufacturing cloud system 104 directly. The vehicle-side AVM algorithm 122 is configured to communicate information and/or instructions to the vehicle central gateway module 126 received from the infrastructure system 110 and/or the vehicle manufacturing cloud system 104.

The vehicle infotainment system 128 delivers a combination of information and entertainment content and/or services to a user 140 of the vehicle 102. It is understood that the vehicle infotainment system 128 can deliver only entertainment content to the user 140 of the vehicle 102, in some examples. It is also understood that the vehicle infotainment system 128 can deliver information services to anyone associated with the vehicle 102, in other examples. As an example, the vehicle infotainment system 128 includes built-in car computers that combine one or more functions, such as digital radios, built-in cameras, and/or televisions. The vehicle infotainment system 128 communicates information associated with the built-in car computers or processors to the vehicle-side AVM algorithm 122. For example, the vehicle 102 utilizes the vehicle-side AVM algorithm 122 to process and send information received from the vehicle infotainment system 128 to the infrastructure system 110. As another example, the vehicle 102 utilizes the vehicle-side AVM algorithm 122 to process and send information received from the vehicle infotainment system 128 to the vehicle manufacturing cloud system 104 directly. The vehicle-side AVM algorithm 122 is configured to communicate information and/or instructions to the vehicle infotainment system 128 received from the infrastructure system 110 and/or the vehicle manufacturing cloud system 104.

The one or more vehicle sensors 130 may be, for example, one or more of cameras, lidar, radar, and/or ultrasonic devices. For example, ultrasonic devices utilized as the one or more vehicle sensors 130 emit a high frequency sound wave that hits a wall or another vehicle and is then reflected back to the vehicle 102. Based on the amount of time it takes for the sound wave to return to the vehicle 102, the vehicle 102 can determine the distance between the one or more vehicle sensors 130 and the wall or the other vehicle. As another example, camera devices utilized as the one or more vehicle sensors 130 provide a visual indication of a space around the vehicle 102. As an additional example, radar devices utilized as the one or more vehicle sensors 130 emit electromagnetic wave signals that hit the wall or the other vehicle and is then reflected back to the vehicle 102. Based on the amount of time it takes for the electromagnetic waves to return to the vehicle 102, the vehicle 102 can determine a range, velocity, and angle of the vehicle 102 relative to the wall or the other vehicle.

The one or more vehicle sensors 130 communicate information associated with the position and/or distance at which the vehicle 102 is relative to the wall or the other vehicle to the vehicle-side AVM algorithm 122. For example, the vehicle 102 utilizes the vehicle-side AVM algorithm 122 to process and send information received from the one or more vehicle sensors 130 to the infrastructure system 110. As another example, the vehicle 102 utilizes the vehicle-side AVM algorithm 122 to process and send information received from the one or more vehicle sensors 130 to the vehicle manufacturing cloud system 104 directly. The vehicle-side AVM algorithm 122 is configured to communicate information and/or instructions to the one or more vehicle sensors 130 received from the infrastructure system 110 and/or the vehicle manufacturing cloud system 104.

The vehicle battery 132 is controlled by a battery management system (not shown) that provides instructions to the vehicle battery 132. For example, the battery management system provides instructions to the vehicle battery 132 based on a temperature of the vehicle battery 132. However, it is understood that the battery management system may provide instructions to the vehicle battery 132 based on any measure associated with the vehicle battery 132 such as power state of the vehicle 102, a time period of at least one day that the vehicle 102 is in an off-state, or a combination thereof. The battery management system ensures acceptable current modes of the vehicle battery 132. For example, the acceptable current modes protect against overvoltage, overcharge, and/or overheating of the vehicle battery 132. As another example, the temperature of the vehicle battery 132 indicates to the battery management system whether any of the acceptable current modes are within acceptable temperate ranges. The battery management system associated with the vehicle battery 132 communicates information associated with the temperature of the vehicle battery 132 to the vehicle-side AVM algorithm 122. For example, the vehicle 102 utilizes the vehicle-side AVM algorithm 122 to process and send information received regarding the vehicle battery 132 to the infrastructure system 110. As another example, the vehicle 102 utilizes the vehicle-side AVM algorithm 122 to process and send information regarding the vehicle battery 132 to the vehicle manufacturing cloud system 104 directly. The vehicle-side AVM algorithm 122 is configured to communicate information and/or instructions to the vehicle battery 132 received from the infrastructure system 110 and/or the vehicle manufacturing cloud system 104.

The vehicle GNSS 134 is configured to communicate with satellites so that the vehicle 102 can determine a specific location of the vehicle 102. The vehicle navigation mapping system 136 can display, via a display screen (not shown), the specific location of the vehicle 102 to the user 140. The vehicle GNSS 134 communicates geographical information associated with the vehicle 102 to the vehicle-side AVM algorithm 122. For example, the vehicle 102 utilizes the vehicle-side AVM algorithm 122 to process and send information received from the vehicle GNSS 134 to the infrastructure system 110. As another example, the vehicle 102 utilizes the vehicle-side AVM algorithm 122 to process and send information from the vehicle GNSS 134 to the vehicle manufacturing cloud system 104 directly. The vehicle-side AVM algorithm 122 is configured to communicate information and/or instructions to the vehicle GNSS 134 received from the infrastructure system 110 and/or the vehicle manufacturing cloud system 104. As another example, the vehicle 102 utilizes the vehicle-side AVM algorithm 122 to process and send information associated with the vehicle navigation mapping system 136 to the infrastructure system 110. As another example, the vehicle 102 utilizes the vehicle-side AVM algorithm 122 to process and send information from the vehicle navigation mapping system 136 to the vehicle manufacturing cloud system 104 directly. The vehicle-side AVM algorithm 122 is configured to communicate information and/or instructions to the vehicle navigation mapping system 136 received from the infrastructure system 110 and/or the vehicle manufacturing cloud system 104.

The vehicle 102 is configured to communicate any information associated with any of the components included within the vehicle 102 to one or more additional vehicles 142. The vehicle 102 is also configured to communicate (e.g., forward) any instructions received from the infrastructure system 110 and/or the vehicle manufacturing cloud system 104 to any of the one or more additional vehicles 142. For example, the communication of the vehicle 102 with the one or more additional vehicles 142 can aid the infrastructure system 110 and/or the vehicle manufacturing cloud system 104 in marshaling the one or more additional vehicles 142. It is understood that each of the one or more additional vehicles 142 can include any of the components described as being included within the vehicle 102, such as the vehicle-side AVM algorithm 122, the wireless transmission module 124, the vehicle central gateway module 126, the vehicle infotainment system 128, the one or more vehicle sensors 130, the vehicle battery 132, the vehicle GNSS 134, the vehicle navigation mapping system 136, and/or the CAN vehicle bus 138, for example. It is also understood that any of the one or more additional vehicles 142 is configured to communicate information associated with any of the components included therein with the vehicle 102. It is further understood that the one or more additional vehicles 142 can also be configured to establish a direct line of wireless communication (e.g., via a communication link) with the infrastructure system 110 and/or the vehicle manufacturing cloud system 104, whereby information can be directly exchanged between the one or more additional vehicles 142 and the infrastructure system 110 and/or the vehicle manufacturing cloud system 104.

The vehicle delivery manager cloud system 106 wirelessly communicates (e.g., receives and/or sends instructions and/or information) with one or more of a rental agencies cloud system 144, a valet parking agencies cloud system 146, an insurance agencies cloud system 148, and/or a dealership system 150. The vehicle delivery manager cloud system 106 is configured to facilitate the delivery of the one or more vehicles to any of a rental agency (not shown) associated with the rental agencies cloud system 144, a valet parking agency (not shown) associated with the valet parking agencies cloud system 146, an insurance agency (not shown) associated with the insurance agencies cloud system 148, and/or the dealership system 150. The vehicle delivery manager cloud system 106 also wirelessly communicates with the vehicle customer web-portal account cloud system 108. It should be understood that other cloud systems can be included, in one or more examples.

The vehicle delivery manager cloud system 106 wirelessly communicates with a user device 152 such as a mobile device, a display panel, and/or a computer. The vehicle 102 is also configured to wirelessly communicate directly with the user device 152. For example, the user 140 engages with the user device 152 via an application that organizes any information and/or instructions received from the vehicle customer web-portal account cloud system 108 and/or the vehicle 102. As another example, the user 140 may send one or more instructions to the vehicle customer web-portal account cloud system 108 such as making a selection of which vehicle the user 140 would like to receive from any of the rental agency associated with the rental agencies cloud system 144, the valet parking agency associated with the valet parking agencies cloud system 146, the insurance agency associated with the insurance agencies cloud system 148, and/or the dealership system 150.

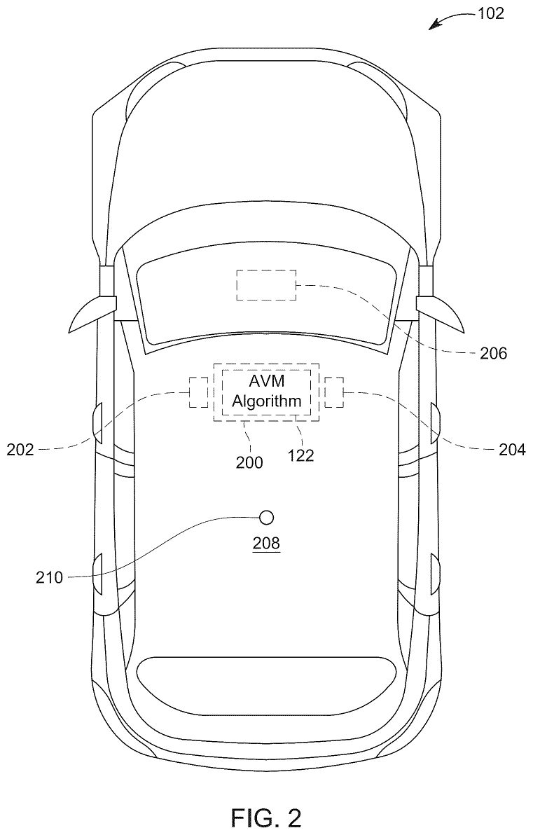

Referring to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally include the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as discussed below, various other controllers and/or sensors provide data to the vehicle controller 200 via the vehicle communication network.

In addition, the vehicle controller 200, via a vehicle-side AVM algorithm 122, is configured for communicating through a vehicle-to-infrastructure communication network, such as communicating with an infrastructure controller (not shown). The vehicle controller 200, via the vehicle-side AVM algorithm 122, is also configured for communicating through a wireless vehicular communication interface with other traffic entities (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic entities. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include detection sensors (e.g., lidar sensor(s)) disposed on or in the vehicle(s) 102 that provide relative locations, sizes, and/or shapes of one or more entities surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the entities relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

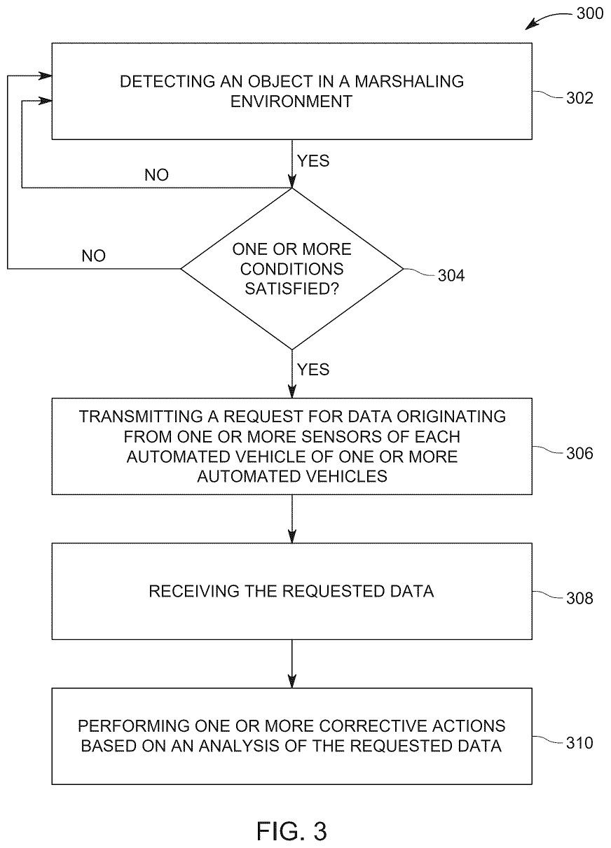

FIG. 3 depicts a process flow illustrating an example process 300 for identifying one or more ghost vehicles within the marshaling environment. At operation 302, the infrastructure system 110 is configured to detect whether there is an object (e.g., a ghost vehicle) present within the marshaling environment. It is understood that while the object is a ghost vehicle, the object can also be any other object that does not physically exist. The infrastructure system 110 continues to monitor the marshaling environment in order to detect the presence of the object within the marshaling environment.

In a case wherein the infrastructure system 110 detects the presence of the object within the marshaling environment, the infrastructure-side AVM algorithm 112 can determine whether one or more conditions is satisfied at operation 304 relative to the identification of any ghost vehicles. In one or more examples the one or more conditions can include one or more of an unexpected location of the object; an inability to identify a historical pathway associated with each automated vehicle of the one or more automated vehicles; an inconsistency between data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated vehicles and an expected total number of automated vehicles of the one or more automated vehicles. In an instance wherein none of the conditions are met (e.g., satisfied), the process 300 returns to operation 302 and the infrastructure system 110 continues to monitor the marshaling environment in order to detect the presence of the object within the marshaling environment.

However, in a case wherein one or more of the conditions are met, the infrastructure system 110 transmits a real-time static check request for data to the one or more automated vehicles at operation 306. In one or more examples, the requested data is for raw data originating from one or more sensors (e.g., the plurality of on-board sensors 204) of each automated vehicle of the one or more automated vehicles. In one or more examples, the data can be one or more image files and/or one or more video files. In another example, other data files can be transmitted between the one or more automated vehicles and the infrastructure system 110 such as, but not limited to, a visual signature, a triangulated location file, an ultra-wide band related file, a radar signature, an ultrasonic signature, among others.

At operation 308, the infrastructure system 110 is configured to receive the requested data from the one or more automated vehicles. In one or more embodiments, the infrastructure-side AVM algorithm 112 is configured to analyze the requested data by determining whether a sensor output associated with the one or more sensors 114 of the infrastructure system 110 matches a sensor output associated with the requested data to identify any ghost vehicles. In another one or more embodiments, the infrastructure-side AVM algorithm 112 is also configured to analyze the requested data by determining whether an isolated software routine specific to the infrastructure system 110 matches an analysis associated with the requested data performed by the vehicle-side AVM algorithm 122 to identify any ghost vehicles. In one or more examples, the determination of whether the isolated software routine matches the analysis associated with the requested data performed by the vehicle-side AVM algorithm 122 is based on a utilization of one or more algorithmic image matching techniques such as pixel matching, object matching, feature matching, dense matching, among others.

At operation 310, one or more corrective actions are performed by the infrastructure system 110 and/or the one or more automated vehicles. In one or more embodiments, one or more reset routines can be initiated in an instance wherein the infrastructure-side AVM algorithm 112 and/or the vehicle-side AVM algorithm 122 excludes any hardware issues causing the detection of ghost vehicle(s). For example, the one or more reset routines can be initiated for hardware and software aspects related to the infrastructure system 110 and/or the one or more automated vehicles.

In one or more embodiments, in an instance wherein an alternative (e.g., redundant) sensor suite (e.g., the one or more sensors 114) is available for the use of the infrastructure system 110, the infrastructure-side AVM algorithm 112 can cause the infrastructure system 110 to switch from the one or more sensors 114 to the alternative sensor suite while the one or more sensors 114 is reset and correct behavior within the marshaling environment is validated. For example, the validation of the correct behavior within the marshaling environment is validated by the infrastructure-side AVM algorithm 112 and/or the vehicle-side AVM algorithm 122 that can both perform one or more validation routines.

In one or more embodiments, a marshaling system routing the one or more automated vehicles can switch to a historical path routing system whereby each automated vehicle of the one or more automated vehicles is caused to follow one or more movements of a preceding automated vehicle of the one or more automated vehicles. For example, a lead automated vehicle of the one or more automated vehicles is caused to follow a historical pathway based on historical data obtained from one or more routes followed by multiple sets of automated vehicles that may pass through the marshaling environment.

In one or more embodiments, the infrastructure-side AVM algorithm 112 and/or the vehicle-side AVM algorithm 122 is configured to analyze metadata associated with each object appearance from the requested data. For example, the infrastructure-side AVM algorithm 112 and/or the vehicle-side AVM algorithm 122 is also configured to determine if certain areas of the marshaling environment are more prone for objects to appear. As another example, the infrastructure-side AVM algorithm 112 and/or the vehicle-side AVM algorithm 122 is further configured to provide a recommendation for replacing any of the one or more sensors 114 or any of the plurality of on-board sensors 204 based on the analysis of the metadata. As a further example, the infrastructure-side AVM algorithm 112 and/or the vehicle-side AVM algorithm 122 is also configured to recommend installation of a redundant sensor suite in certain areas of the marshaling environment to support at least the one or more sensors 114 based on the analysis of the metadata.

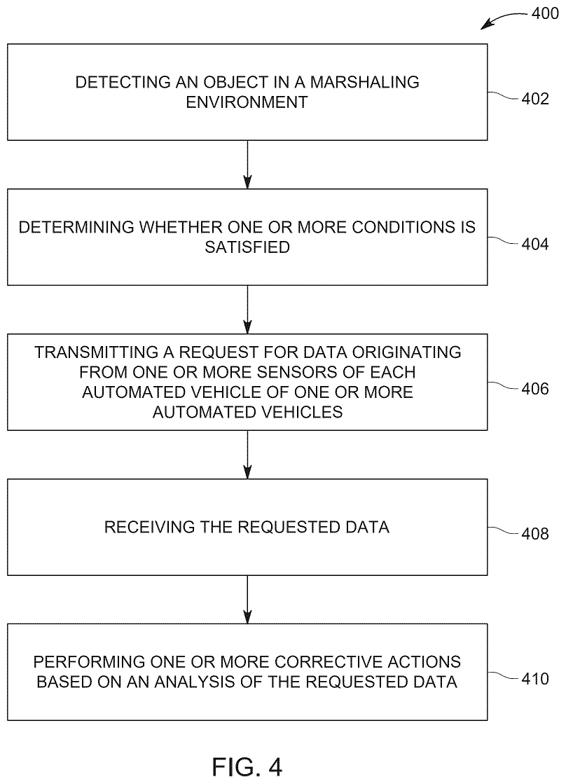

FIG. 4 is a flowchart illustrating another example method 400 for identifying one or more ghost vehicles within the marshaling environment. At operation 402, an object (e.g., a ghost vehicle) is detected in the marshaling environment.

At operation 404, a determination is made regarding whether one or more conditions is satisfied relative to the identification of any ghost vehicles. For example, the determination of whether the one or more conditions is satisfied is made by an infrastructure system (e.g., the infrastructure system 110). As another example, the determination of whether the one or more conditions is satisfied is made in response to the detection of the object. As a further example, the one or more conditions includes one or more of an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles.

At operation 406, a request for data originating from one or more sensors (e.g., the plurality of on-board sensors 204) of each automated vehicle (e.g., the vehicle 102) of one or more automated vehicles is transmitted to the one or more automated vehicles. For example, the request for data is transmitted in response to the one or more conditions being satisfied (e.g., any of the conditions being met). At operation 408, the requested data is received from the one or more automated vehicles.

At operation 410, one or more corrective actions is performed. For example, the one or more corrective actions is performed based on an analysis of the requested data. In one more examples, the analysis of the requested data comprises a determination of whether a sensor output associated with one or more sensors (e.g., the one or more sensors 114) of an infrastructure system matches the requested data to identify any ghost vehicles. For example, the performance of the one or more corrective actions is further based on a determination that the sensor output does not match the requested data. In one or more examples, the performance of the one or more corrective actions includes one of an initiation of one or more reset routines, switching from a first set of one or more sensors of an infrastructure system to a second set of one or more sensors of the infrastructure system, and causing each automated vehicle of the one or more automated vehicles to follow one or more movements of a preceding automated vehicle of the one or more automated vehicles and for a lead automated vehicle of the one or more automated vehicles to follow a historical pathway. In one or more examples, the performance of the one or more corrective actions includes collecting metadata associated with the object includes collecting metadata associated with the object, determining one or more object-prone areas within the marshaling environment, and/or generating a recommendation to replace one or more sensors of an infrastructure system or to install a second set of one or more sensors based on the determination of the one or more object-prone areas.

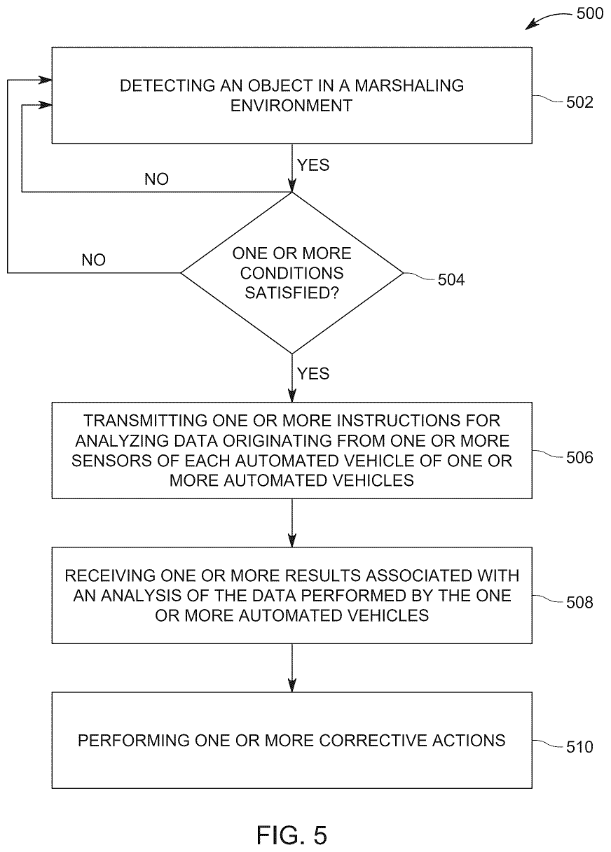

FIG. 5 depicts a process flow illustrating an additional example process 500 for identifying one or more ghost vehicles within the marshaling environment. At operation 502, the infrastructure system 110 is configured to detect whether there is an object (e.g., a ghost vehicle) present within the marshaling environment. The infrastructure system 110 continues to monitor the marshaling environment in order to detect the presence of the object within the marshaling environment.

In a case wherein the infrastructure system 110 detects the presence of the object within the marshaling environment, the infrastructure-side AVM algorithm 112 can determine whether one or more conditions is satisfied at operation 504 relative to the identification of any ghost vehicles. In one or more examples, the one or more conditions can include one or more of an unexpected location of the object; an inability to identify a historical pathway associated with each automated vehicle of the one or more automated vehicles; an inconsistency between data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles. In an instance wherein none of the conditions are met (e.g., satisfied), the process 500 returns to operation 502 and the infrastructure system 110 continues to monitor the marshaling environment in order to detect the presence of the object within the marshaling environment.

However, in a case wherein one or more of the conditions are met, the infrastructure system 110 transmits a real-time static check request that can include one or more instructions for analyzing data originating from one or more sensors (e.g., the plurality of on-board sensors 204) of each automated vehicle of the one or more automated vehicles at operation 506. As an example, the data can be one or more image files and/or one or more video files.

In one or more examples, the one or more instructions can direct the vehicle-side AVM algorithm 122 of each automated vehicle of the one or more automated vehicles to perform a verification process to determine whether the object is at the location as indicated by the one or more sensors 114 of the infrastructure system 110 and/or the plurality of on-board sensors 204 of each automated vehicle of the one or more automated vehicles. In one or more examples, the verification process can comprise of each automated vehicle of the one or more automated vehicles analyzing stored video clips originating from the plurality of on-board sensors 204 of each automated vehicle of the one or more automated vehicles. The stored video clips can be of any length of time and can be stored within a database internally disposed within each automated vehicle of the one or more automated vehicles or externally disposed in a cloud system (e.g., the vehicle manufacturing cloud system 104 or the vehicle customer web-portal account cloud system 108) or the infrastructure system 110, for example.

In one or more embodiments, it is understood that the process described as part of operation 506 can be an isolated request as part of the process 500 or can provide additional processes to those described as part of operation 406.

At operation 508, the infrastructure system 110 is configured to receive one or more results associated with the analysis of the stored video (e.g., the verification process) from the one or more automated vehicles. In one or more examples, the one or more results can include information associated with whether each automated vehicle of the one or more automated vehicles is able to verify whether or not the object is at the location as indicated by the one or more sensors 114 of the infrastructure system 110 and/or the plurality of on-board sensors 204 of each automated vehicle of the one or more automated vehicles. In other words, the one or more results can indicate that the object is at the location or that the object is not at the location. At operation 510, one or more corrective actions are performed by the infrastructure system 110 and/or the one or more automated vehicles. In one or more embodiments, one or more reset routines can be initiated in an instance wherein the infrastructure-side AVM algorithm 112 and/or the vehicle-side AVM algorithm 122 excludes any hardware issues causing the detection of ghost vehicle(s). For example, the one or more reset routines can be initiated for hardware and software aspects related to the infrastructure system 110 and/or the one or more automated vehicles. In one or more examples, the one or more reset routines can be a hard reset, a soft reset, or any other type of reset.

In one or more embodiments, in an instance wherein an alternative (e.g., redundant) sensor suite (e.g., the one or more sensors 114) is available for the use of the infrastructure system 110, the infrastructure-side AVM algorithm 112 can cause the infrastructure system 110 to switch from the one or more sensors 114 to the alternative sensor suite while the one or more sensors 114 is reset and correct behavior within the marshaling environment is validated. For example, the validation of the correct behavior within the marshaling environment is validated by the infrastructure-side AVM algorithm 112 and/or the vehicle-side AVM algorithm 122 that can both perform one or more validation routines.

In one or more embodiments, a marshaling system routing the one or more automated vehicles can switch to a historical path routing system whereby each automated vehicle of the one or more automated vehicles is caused to follow one or more movements of a preceding automated vehicle of the one or more automated vehicles. For example, a lead automated vehicle of the one or more automated vehicles is caused to follow a historical pathway based on historical data obtained from one or more routes followed by many sets of automated vehicles that may pass through the marshaling environment.

In one or more embodiments, the infrastructure-side AVM algorithm 112 and/or the vehicle-side AVM algorithm 122 is configured to analyze metadata associated with each object appearance from the requested data. For example, the infrastructure-side AVM algorithm 112 and/or the vehicle-side AVM algorithm 122 is also configured to determine if certain areas of the marshaling environment are more likely for objects to appear. As another example, the infrastructure-side AVM algorithm 112 and/or the vehicle-side AVM algorithm 122 is further configured to provide a recommendation for replacing any of the one or more sensors 114 or any of the plurality of on-board sensors 204 based on the analysis of the metadata. As a further example, the infrastructure-side AVM algorithm 112 and/or the vehicle-side AVM algorithm 122 is also configured to recommend installation of a redundant sensor suite in certain areas of the marshaling environment to support at least the one or more sensors 114 based on the analysis of the metadata.

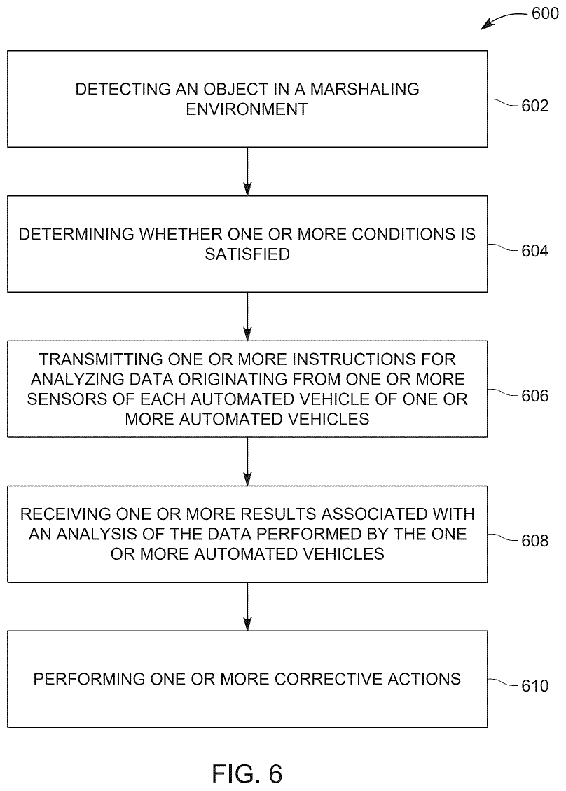

FIG. 6 is a flowchart illustrating yet another example method 600 for identifying one or more ghost vehicles within the marshaling environment. At operation 602, an object (e.g., a ghost vehicle) is detected in the marshaling environment.

At operation 604, a determination is made regarding whether one or more conditions is satisfied relative to the identification of any ghost vehicles. For example, the determination of whether the one or more conditions is satisfied is made by an infrastructure system (e.g., the infrastructure system 110). As another example, the determination of whether the one or more conditions is satisfied is made in response to the detection of the object. As a further example, the one or more conditions includes one or more of an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles.

At operation 606, one or more instructions for analyzing data originating from one or more sensors (e.g., the plurality of on-board sensors 204) of each automated vehicle (e.g., the vehicle 102) of the one or more automated vehicles is transmitted to the one or more automated vehicles. For example, the one or more instructions is transmitted in response to the one or more conditions being satisfied (e.g., any of the conditions being met). In one or more examples, the one or more instructions can direct the vehicle-side AVM algorithm 122 of each automated vehicle of the one or more automated vehicles to perform a verification process to determine whether the object is at the location as indicated by the one or more sensors 114 of the infrastructure system 110 and/or the plurality of on-board sensors 204 of each automated vehicle of the one or more automated vehicles. In one or more examples, the verification process can comprise of each automated vehicle of the one or more automated vehicles analyzing stored video clips originating from the plurality of on-board sensors 204 of each automated vehicle of the one or more automated vehicles. The stored video clips can be of any length of time and can be stored within a database internally disposed within each automated vehicle of the one or more automated vehicles or externally disposed in a cloud system (e.g., the vehicle manufacturing cloud system 104 or the vehicle customer web-portal account cloud system 108) or the infrastructure system 110, for example.

At operation 608, one or more results is received from the one or more automated vehicles. For example, the one or more results is associated with an analysis of the data (e.g., the verification process) performed by the one or more automated vehicles. In one or more examples, the analysis of the data comprises an analysis of one or more video recordings of the marshaling environment from each automated vehicle of the one or more automated vehicles and/or a verification of a location of the object based on the analysis of the one or more video recordings. In one or more examples, the one or more results can include information associated with whether each automated vehicle of the one or more automated vehicles is able to verify whether or not the object is at the location as indicated by the one or more sensors 114 of the infrastructure system 110 and/or the plurality of on-board sensors 204 of each automated vehicle of the one or more automated vehicles. In other words, the one or more results can indicate that the object is at the location or that the object is not at the location.

At operation 610, one or more corrective actions is performed. For example, the one or more corrective actions is performed based on the one or more results associated with the analysis of the data. In one or more examples, the performance of the one or more corrective actions includes one of an initiation of one or more reset routines, switching from a first set of one or more sensors of an infrastructure system to a second set of one or more sensors of the infrastructure system, and causing each automated vehicle of the one or more automated vehicles to follow one or more movements of a preceding automated vehicle of the one or more automated vehicles and for a lead automated vehicle of the one or more automated vehicles to follow a historical pathway. In one or more examples, the one or more reset routines can be a hard reset, a soft reset, or any other type of reset. In one or more examples, the performance of the one or more corrective actions includes collecting metadata associated with the object, determining one or more object-prone areas within a marshaling environment, and/or generating a recommendation to replace one or more sensors of an infrastructure system or to install a second set of one or more sensors based on the determination of the one or more object-prone areas.

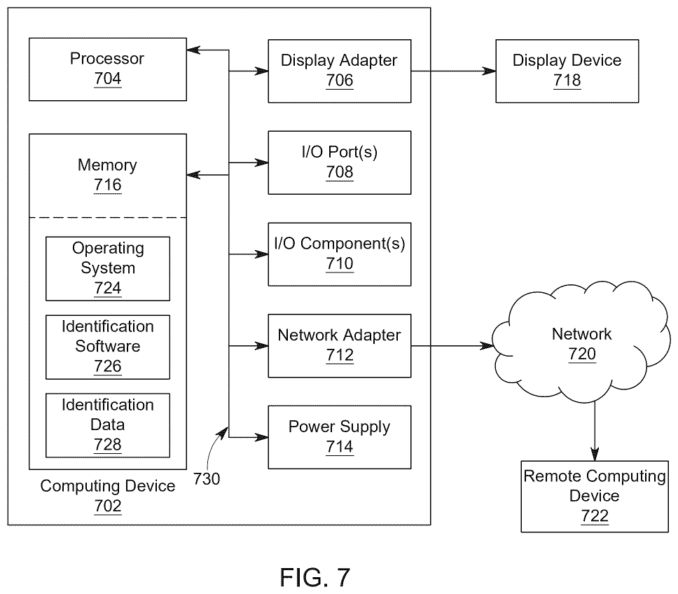

FIG. 7 illustrates an operating environment that facilitates the performance of one or more systems and methods described herein. More specifically, the systems and methods described herein can be implemented using a computing device 702. For example, the computing device 702 can be a personal computer, a desktop, a laptop, a tablet, a hand-held computer, a server, a workstation, a mainframe, a wearable computer, a supercomputer, or a combination thereof. However, it is understood that the aforementioned examples of the computing device 702 is non-exhaustive and the computing device 702 can be any type of processing or computing device. The computing device 702 generally includes a processor 704, a display adapter 706, one or more input/output port(s) 708, one or more input/output component(s) 710, a network adapter 712, a power supply 714, and a memory 716. However, it is understood that the computing device 702 can include any additional components therein and is not required to include any of the listed components (e.g., the processor 704, the display adapter 706, the one or more input/output port(s) 708, the one or more input/output component(s) 710, the network adapter 712, the power supply 714, and the memory 716).

The processor 704 is configured to provide instructions to the computing device 702 so that the computing device 702 can process one or more tasks including the implementation of a software program to perform one or more operations as described in more detail herein. It is also understood that the computing device 702 may include any number or processors 704 therein. The display adapter 706 can be a graphics card or a video board that provides the computing device 702 with a capability to display content on a display device 718. For example, the display device 718 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 718 is non-exhaustive and that the display device 718 can be any type of device capable of providing a visual display.

The input/output port(s) 708 provide a number of interfaces (e.g., sockets) for one or more cables to connect to the computing device 702. It is understood that there may be any number of input/output port(s) 708 on the computing device 702. For example, the input/output port(s) 708 provides a means for the computing device 702 to receive signals and/or data from an external device connected to the computing device 702 via the one or more cables. As another example, the input/output port(s) 708 provide a means for the computing device 702 to send signals and/or data to an external device connected to the computing device 702 via the one or more cables. The input/output component(s) 710 can include one or more components that support the input/output port(s) 708 such as, but not limited to, a switch, a push button, a pressure mat, a float switch, a keypad, a radio receive, or a combination thereof.

The network adapter 712 can be any type of network interface controller that is configured to provide a means for communicating over a network 720 with another computing device, such as a remote computing device 722. For example, the remote computing device 722 can be a user device such as a cellular-phone, a smartphone, a tablet, a laptop, or a combination thereof. The power supply 714 is configured to convert alternating high voltage current (e.g., AC) into direct current (e.g., DC) to provide power to the other components (e.g., the processor 704, the display adapter 706, the one or more input/output port(s) 708, the one or more input/output component(s) 710, the network adapter 712, and the memory 716) of the computing device 702.

Additionally, the memory 716 can be a mass storage device and/or a system memory such as a hard disk drive, a memory card, a solid-state drive, RAM, or a combination thereof. The memory 716 is configured to provide storage for instructions and data associated with the operation of the computing device 702. The memory 716 can generally include an operating system 724, identification software 726, and identification data 728 to perform one or more operations described in more detail herein. For example, the operating system 724 is configured to manage and/or process any of the data and/or instructions associated with the identification software 726 and/or the identification data 728, as described in more detail herein.

Furthermore, a system bus 730 is also included within the computing device 702 that is configured to couple each of the various components (e.g., the processor 704, the display adapter 706, the one or more input/output port(s) 708, the one or more input/output component(s) 710, the network adapter 712, the power supply 714, and the memory 716) of the computing device 702. It is also understood that each of the components of the computing device 702, and the functionality associated with each of the components of the computing device 702, may be implemented within the remote computing device 722. While the operating environment illustrated within FIG. 7 depicts a particular configuration associated with at least the computing device 702, the network 720, and the remote computing device 722, it is understood that the operating environment may be configured in any way.

Thus, one or more examples of the present disclosure provides a means for identifying a ghost vehicle in consideration of data analysis associated with a perception of a marshaling environment from a perspective of an infrastructure system and/or one or more vehicles. Based on the data analysis, one or more corrective actions can be made to ensure a seamless and swift resolution to the detection of the ghost vehicle within the marshaling environment without disrupting a marshaling process associated with the one or more vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
detecting an object in a marshaling environment;
determining whether one or more conditions is satisfied in response to the detection of the object;
transmitting, to one or more automated vehicles, a request for data originating from one or more sensors of each automated vehicle of the one or more automated vehicles in response to the one or more conditions being satisfied;
receiving, from the one or more automated vehicles, the requested data; and
performing one or more corrective actions based on an analysis of the requested data.

2. The method of claim 1, wherein the one or more conditions includes one or more of:
an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles.

3. The method of claim 1, wherein the analysis of the requested data comprises:
determining whether a sensor output associated with one or more sensors of an infrastructure system matches the requested data.

4. The method of claim 3, wherein the performance of the one or more corrective actions is further based on a determination that the sensor output does not match the requested data.

5. The method of claim 1, wherein the performance of the one or more corrective actions includes one of:
initiating one or more reset routines;
switching from a first set of one or more sensors of an infrastructure system to a second set of one or more sensors of the infrastructure system; and
causing each automated vehicle of the one or more automated vehicles to follow one or more movements of a preceding automated vehicle of the one or more automated vehicles and for a lead automated vehicle of the one or more automated vehicles to follow a historical pathway.

6. The method of claim 1, wherein the performance of the one or more corrective actions includes:
collecting metadata associated with the object;
determining one or more object-prone areas within the marshaling environment; and
generating a recommendation to replace one or more sensors of an infrastructure system or to install a second set of one or more sensors based on the determination of the one or more object-prone areas.

7. A method comprising:
detecting an object in a marshaling environment;
determining whether one or more conditions is satisfied in response to the detection of the object;
transmitting, to one or more automated vehicles, one or more instructions for analyzing data originating from one or more sensors of each automated vehicle of the one or more automated vehicles in response to the one or more conditions being satisfied;
receiving, from the one or more automated vehicles, one or more results associated with an analysis of the data performed by the one or more automated vehicles; and
performing one or more corrective actions based on the one or more results associated with the analysis of the data.

8. The method of claim 7, wherein the one or more conditions includes one or more of:
an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles.

9. The method of claim 7, wherein the analysis of the data by the one or more automated vehicles further comprises:
analyzing one or more video recordings of the marshaling environment from each automated vehicle of the one or more automated vehicles; and
verifying a location of the object based on the analysis of the one or more video recordings.

10. The method of claim 7, wherein the performance of the one or more corrective actions includes one of:
initiating one or more reset routines;
switching from a first set of one or more sensors of an infrastructure system to a second set of one or more sensors of the infrastructure system; and
causing each automated vehicle of the one or more automated vehicles to follow one or more movements of a preceding automated vehicle of the one or more automated vehicles and for a lead automated vehicle of the one or more automated vehicles to follow a historical pathway.

11. The method of claim 7, wherein the performance of the one or more corrective actions includes:
collecting metadata associated with the object;
determining one or more object-prone areas within a marshaling environment; and
generating a recommendation to replace one or more sensors of an infrastructure system or to install a second set of one or more sensors based on the determination of the one or more object-prone areas.

12. A system comprising:
an infrastructure system configured to:
detect an object in a marshaling environment,
determine whether one or more conditions is satisfied in response to the detection of the object,
transmit a request for data originating from one or more sensors of each automated vehicle of one or more automated vehicles in response to the one or more conditions being satisfied,
receive the requested data, and
perform one or more corrective actions based on an analysis of the requested data; and
one or more automated vehicles configured to:
receive the request for the data originating from the one or more sensors of each automated vehicle of the one or more automated vehicles, and
transmit the requested data.

13. The system of claim 12, wherein the one or more automated vehicles is further configured to:
receive one or more instructions for analyzing the data originating from the one or more sensors of each automated vehicle of the one or more automated vehicles in response to the one or more conditions being satisfied; and
transmit one or more results associated with the analysis of the data performed by the one or more automated vehicles.

14. The system of claim 13, wherein the infrastructure system is further configured to:
transmit the one or more instructions for analyzing the data originating from the one or more sensors of each automated vehicle of the one or more automated vehicles; and
receive the one or more results.

15. The system of claim 13, wherein performing the analysis of the data by the one or more automated vehicles comprises:
analyzing one or more video recordings of the marshaling environment from each automated vehicle of the one or more automated vehicles; and
verifying a location of the object based on the analysis of the one or more video recordings.

16. The system of claim 12, wherein the one or more conditions includes one or more of:
an unexpected location of the object; an inability to identify a historical pathway associated with each automated vehicle of the one or more automated vehicles; an inconsistency between the data originating from the one or more sensors and a controlled location of the one or more automated vehicles, a relative position of the one or more automated vehicles, or a combination thereof; unexpected spacing between each automated vehicle of the one or more automated vehicles; an inability to account for a location of each automated vehicle of the one or more automated vehicles; and an inconsistency between a total number of automated vehicles of the one or more automated and an expected total number of automated vehicles of the one or more automated vehicles.

17. The system of claim 12, wherein analyzing the requested data by the infrastructure system comprises:
determining whether a sensor output associated with one or more sensors of the infrastructure system matches the requested data.

18. The system of claim 17, wherein the performance of the one or more corrective actions is further based on a determination that the sensor output does not match the requested data.

19. The system of claim 12, wherein performing the one or more corrective actions by the infrastructure system comprises one of:
initiating one or more reset routines;
switching from a first set of one or more sensors of the infrastructure system to a second set of one or more sensors of the infrastructure system; and
causing each automated vehicle of the one or more automated vehicles to follow one or more movements of a preceding automated vehicle of the one or more automated vehicles and for a lead automated vehicle of the one or more automated vehicles to follow a historical pathway.

20. The system of claim 12, wherein performing the one or more corrective actions by the infrastructure system comprises:
collecting metadata associated with the object;
determining one or more object-prone areas within the marshaling environment; and
generating a recommendation to replace one or more sensors of the infrastructure system or to install a second set of one or more sensors based on the determination of the one or more object-prone areas.
